(19) United States
(12) Patent Application Publication
(10) Pub. No.: US 2020/0111032 A1
(43) Pub. Date: Apr. 9, 2020

(54) TIME SETTING DEVICE FOR INPUTTING AND DETECTING RESERVATION INFORMATION

(71) Applicant: JE YOOK SON, Daejeon (KR)

(72) Inventor: JE YOOK SON, Daejeon (KR)

(21) Appl. No.: 16/225,400

(22) Filed: Dec. 19, 2018

(30) Foreign Application Priority Data
Oct. 5, 2018 (KR) 10-2018-0118570

(51) Int. Cl. G06Q 10/02; G06F 3/0484; G06F 3/0487

(52) U.S. Cl. CPC G06Q 10/02; G06F 3/0487; G06F 3/04842

(57) ABSTRACT

According to an embodiment, a time setting device may be installed on an electronic device including a communication unit, a memory, a touchscreen, a controller, and a key input device. The time setting device may be configured to display time sections partitioned per hour or minute on a clock-shaped background, enable a reservation to be set by selecting at least one of the time sections, and display preset reservation information on at least one of the time sections.

### CROSS-REFERENCE TO RELATED APPLICATION(S)

This application is based on and claims priority under 35 U.S.C. § 119 to Korean Patent Application No. 10-2018-0118570, filed on Oct. 5, 2018, in the Korean Intellectual Property Office, the disclosure of which is incorporated by reference herein in its entirety.

### TECHNICAL FIELD

Embodiments of the disclosure relate to time setting device easy to input and grasp reservation information, and more specifically, to time setting devices that may provide a user-centered interface to allow for easier entry of reservation information and easily figure out information regarding reservations previously made, thereby preventing duplicate reservations.

### DISCUSSION OF RELATED ART

While most venues, such as restaurants, clinics, hotels, etc. in the vast majority of the world do not require a reservation, more and more tend to adopt a policy to require a reservation, and some may require an appoint booked for weeks in advance.

The modern reservation system evolved from the prior practice of arranging catering at a restaurant.

In recent times, many restaurants have replaced the traditional pencil and notebook with an online reservation system. Some websites or apps exist which provide this service for multiple venues.

Meanwhile, there oftentimes occur some issues with reservations, such as so-called “no-shows”—customers who make reservations and then never show up which can chip away at a restaurant's profits.

There are a few conventional techniques for facilitating reservations online. However, such conventional techniques are quite burdensome in choosing a date or time of reservation due to a complicated interface with a number of dense menu items or fail to provide an intuitive interface to users. In other words, most of the conventional reservation interfaces are not user-friendly nor user-centered and inconvenient to handle.

### SUMMARY

Embodiments of the disclosure have been conceived to address the issues with the conventional art, and embodiments of the disclosure aim to provide a user-centered or user-friendly interface allowing for entry of reservation information, e.g., reservation date or time, in an easy and convenience manner.

According to an embodiment, a time setting device may be installed on an electronic device including a communication unit, a memory, a touchscreen, a controller, and a key input device. The time setting device may be configured to display time sections partitioned per hour or minute on a clock-shaped background, enable a reservation to be set by selecting at least one of the time sections, and display preset reservation information on at least one of the time sections.

According to an embodiment, a time setting device may comprise a reservation information transceiver configured to receive confirmed reservation information regarding a reservation previously made and confirmed from a reservation managing server through a communication network or transmit input reservation information entered to the reservation managing server through the communication network, an interface unit configured to display time sections partitioned per hour or per minute on a clock-shaped background on a touchscreen, a database configured to store and manage the input reservation information entered through the interface unit, and a reservation information controller configured to control a screen displayed on the interface unit based on setting reservation information including a reservable date or a reservable time, transmit the input reservation information through the reservation information transceiver to the reservation managing server, and control the time sections displayed on the interface unit based on the confirmed reservation information received from the reservation managing server.

The interface unit may include a date input interface configured to enter a year, a month, or a day and a time input interface configured to enter a reservation time based on a date entered through the date input interface.

The interface unit, the database, and the reservation information controller may be configured in an application installed on an electronic device including a communication unit, a memory, a touchscreen, a controller, and a key input device.

The electronic device may include at least one of a mobile device or a smartwatch.

According to various embodiments, there may be provided a user-centered or user-friendly interface allowing for entry of reservation information, e.g., reservation date or time, in an easy and convenience manner.

Further, information about reservations previously made may be displayed on the interface, preventing duplicate reservations.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a view illustrating a configuration of a reservation managing system to which a time setting device is applied according to an embodiment;

FIG. 2 is a view illustrating a configuration of an electronic device to which a time setting device is applied according to an embodiment;

FIG. 3 is a view illustrating a configuration of a time information setting agent applied to a time setting device according to an embodiment;

FIGS. 4a, 4b, and 4c are views illustrating examples of a date input interface applied to a time information setting device according to an embodiment;

FIG. 5 is a view illustrating examples of a date input interface applied to a time information setting device according to an embodiment;

FIGS. 6a and 6b are views illustrating examples of a time input interface applied to a time information setting device according to an embodiment;

FIG. 7 is a view illustrating an example of a time input interface applied to a time information setting device according to an embodiment; and

FIG. 8 is a view illustrating examples of a confirmed reservation interface applied to a time information setting device according to an embodiment.

### DETAILED DESCRIPTION OF EXEMPLARY EMBODIMENTS

Hereinafter, exemplary embodiments of the disclosure will be described in detail with reference to the accompanying drawings. The same reference denotations may be used to refer to the same or substantially the same elements throughout the specification and the drawings. The disclosure, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

Various changes may be made to the disclosure, and the disclosure may come with a diversity of embodiments. Some embodiments of the disclosure are shown and described in connection with the drawings. However, it should be appreciated that the disclosure is not limited to the embodiments, and all changes and/or equivalents or replacements thereto also belong to the scope of the disclosure.

Embodiments of the disclosure relate to time setting device easy to input and grasp reservation information, and more specifically, to time setting devices that may provide a user-centered interface to allow for easier entry of reservation information and easily figure out information regarding reservations previously made, thereby preventing duplicate reservations.

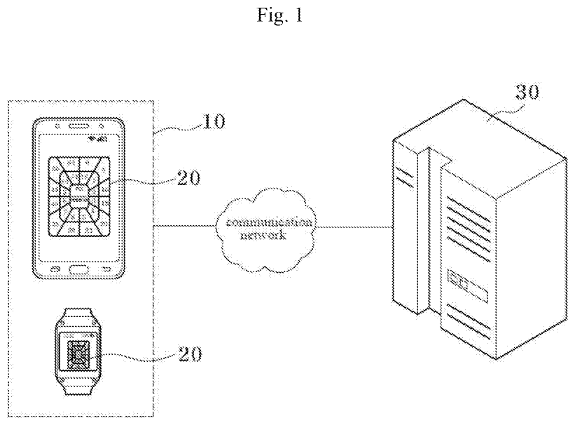

FIG. 1 is a view illustrating a configuration of a reservation managing system to which a time setting device is applied according to an embodiment.

Referring to FIG. 1, a reservation managing system to which a time setting device is applied may include an electronic device 10 where a time information setting agent 20 is installed and a reservation managing server 30 connected with the electronic device 10 via communication.

The time information setting agent 20 may be, or include, an application or program that may be downloaded and installed on the electronic device 10 or that may be embedded in the electronic device 10.

According to an embodiment, where the time information setting agent 20 is an application, the time information setting agent 20 may be downloaded from an app store or the reservation managing server 30 and be installed on the electronic device 10 by the user's manipulation or by accessing the reservation managing server 30.

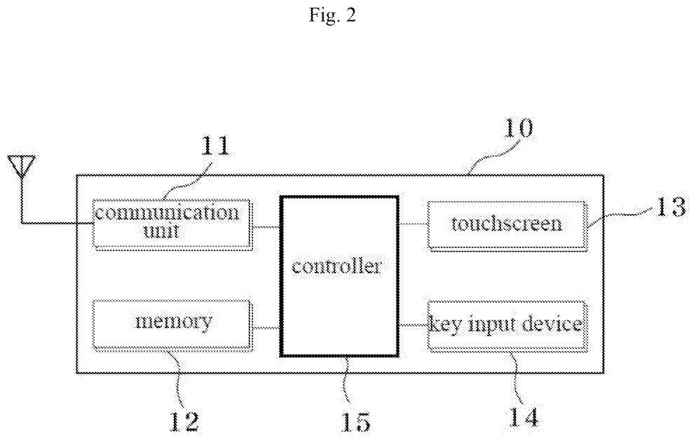

FIG. 2 is a view illustrating a configuration of an electronic device to which a time setting device is applied according to an embodiment.

Referring to FIG. 2, the electronic device 10 may include a communication unit 11, a memory 12, a touchscreen 13, a key input device 14, and a controller 15.

The communication unit 11 may be a wireless communication device for data communication with a communication network. For example, the communication unit 11 may include a mobile communication module provided from a mobile communication service carrier or a wireless-fidelity (Wi-Fi) module for Wi-Fi communication to transmit or receive calls or messages. The communication unit 11 may include a module to enable access to the Internet.

The memory 12 may store a predetermined program to control the overall operation of the electronic device 10 and may store various types or pieces of data input/output or processed when the overall operation of the electronic device 10 is performed by the controller 15.

The touchscreen 13 may perform an output function, such as displaying various pieces of information or the state of the electronic device 10 by a control signal output from the controller 15, and an input function to receive various pieces of information or commands from the user by the user's touch.

The key input device 14 may receive various pieces of information or commands from the user and be an input means or device including various number keys, direction keys, or at least one other key assigned with a predetermined function.

The controller 15 may control the components, e.g., the communication unit 11, the memory 12, the touchscreen 13, and the key input device 14, and controls the overall operation of the electronic device 10.

According to an embodiment, the electronic device 10 may further include at least one of a broadcast receiving module to receive broadcast signals from a broadcast network, a communication module to communicate with a wireless Internet network, a camera module, a vibration module to generate vibrations, or various sensors.

The electronic device 10 may be, or include, but is not limited to, a smartphone, a personal digital assistant (PDA), an electronic wallet, a laptop computer, a personal computer, or other various mobile devices, a wearable device, e.g., a smartwatch, capable of communicating with a smartphone, or any other devices capable of downloading and installing apps or programs through a communication network.

According to an embodiment, the time setting device may be installed on the electronic device 10 and be configured to display sections partitioned on a per-hour basis or a per-minute basis on a a watch or clock-look background screen so that the user selects a section to set a reservation. Preset reservation information may be displayed on the sections.

For example, an interface looking like a watch or clock may be displayed on the touchscreen 13 of the electronic device 10 through an interface unit, and the interface may have a plurality of sections, e.g., hour sections or minute sections, partitioned from each other. The user may easily input reservation information by touching one of the sections.

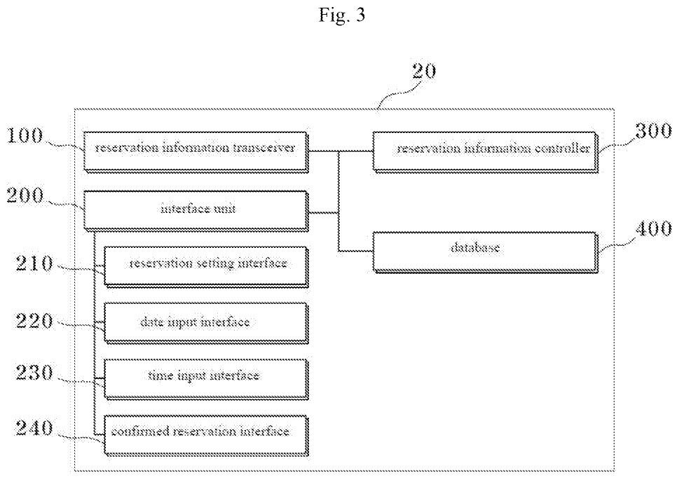

FIG. 3 is a view illustrating a configuration of a time information setting agent applied to a time setting device according to an embodiment.

Referring to FIG. 3, the time information setting agent 20 may include a reservation information transceiver 100, an interface unit 200, a database 300, and a reservation information controller 400. For example, the time information setting agent 20 may be, or be included in, a time setting device according to an embodiment.

The reservation information transceiver 100 may receive confirmed reservation information, which has been reservation information previously made and confirmed, from the reservation managing server 30 or may transmit input reservation information, which is to reservation information entered by, e.g., a user, to the reservation managing server 30.

The reservation information transceiver 100 may access or connect to the reservation managing server 30 via a communication network in association with the communication unit 11 of the electronic device 10.

The confirmed reservation information may be information regarding a reservation previously made by a third-party user. Duplicate reservations may be prevented by receiving information regarding reservations previously made.

The interface unit 200 may display sections partitioned on a per-hour basis or a per-minute basis on a watch-look background screen on the touchscreen 13.

The interface unit 200 may include a reservation setting interface 210, a date input interface 220, a time input interface 230, and a confirmed reservation interface 240. The interface unit 200 may be configured as a set or group of, or database including, the above-enumerated interfaces 210, 220, 230, and 240 or in hardware (e.g. a device configured to provide, output, or display the interfaces 210, 220, 230, and 240) or in software (e.g., an application configured to provide, output, or display the interfaces 210, 220, 230, and 240).

The reservation setting interface 210 may receive an input for such information as, e.g., reservable dates (or days), reservable times, a break time, reservation time intervals, and a reservation number limit from a manager and generate setting reservation information about available reservations based on the received information.

The manager may refer to a person who manages a reservation managing server to take reservations in relation to a hospital, restaurant, hotel, travel agency, store, or other company to provide such services.

For example, the manager sets dates, times, and headcount available for their services through the reservation setting interface 210, and the reservation setting interface 210 may generate setting reservation information based on the information entered by the manager.

The setting reservation information may be configured to be differentiated weekly, monthly, or annually and be applied simultaneously or in batches.

The reservation time interval may be set to be one among every five minutes through every sixth minutes, and a reservation number limit (e.g., the maximum numbers of people allowed for reservations) may be set for each reservation time interval.

For example, for a hospital, clinic, or doctor office, the reservation time interval may be set to 10 minutes during which three people may make their respective reservations.

The reservable dates (or days), reservable times, break time, reservation time intervals, and reservation number limit set through the reservation setting interface 210 may be used as basic or default data for entry of dates or partitioning hour sections through the date input interface 220 and the time input interface 230.

The date input interface 220 may be an interface displayed for entry or input of year, month, or date.

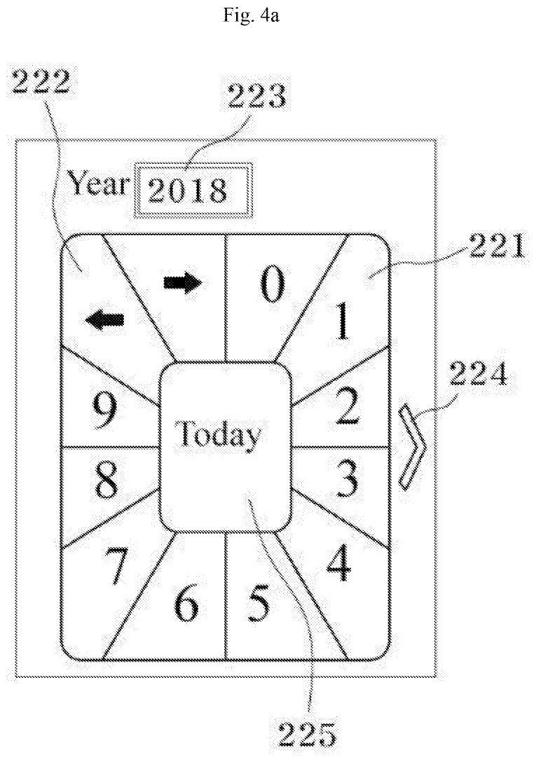

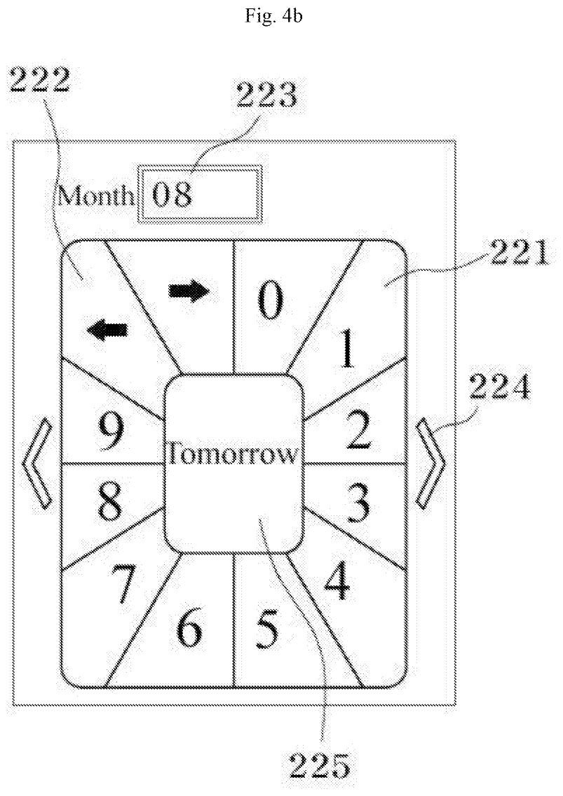

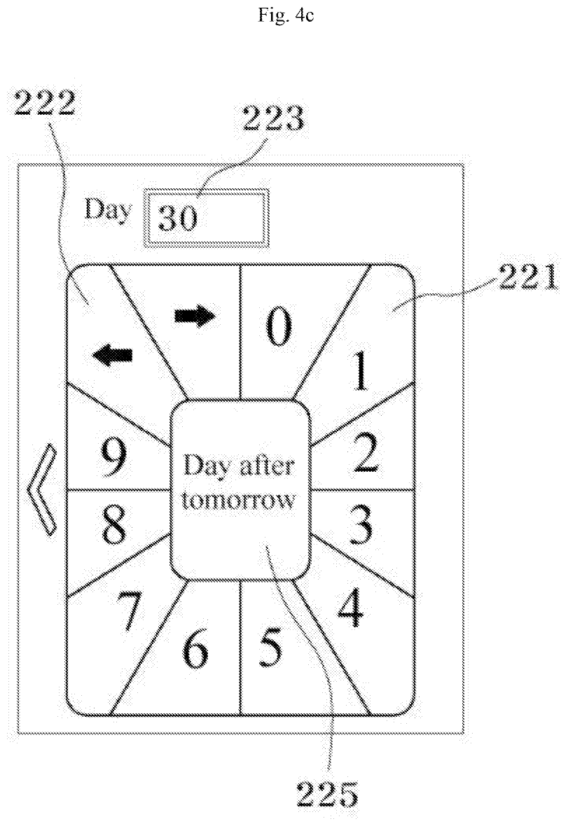

FIGS. 4a, 4b, and 4c are views illustrating examples of a date input interface applied to a time information setting device according to an embodiment.

FIG. 4a illustrates a year input interface for entering a year, FIG. 4b illustrates a month input interface for entering a month, and FIG. 4c illustrates a day input interface for entering a date.

Referring to FIGS. 4a, 4b, and 4c, each date input interface may include a clock-look background which is partitioned into sections per hour, number icons 221 to display the numbers 1, 2, 3, 4, 5, 6, 7, 8, 9, and 0 on their respective corresponding hour sections, edit icons 222 to edit a selected number, a selection display window 223 to display a selected number, and shift icons 224 to shift to another date input interface.

The edit icons 222 may include a number delete button to delete a wrong input to the number icons and a right shift button to shift the cursor to the right.

The shift icons 224 may be configured to shift from the year input interface to the month input interface, from the month input interface to the day input interface, from the day input interface to the month input interface, or from the month input interface to the year input interface. The shift icons 224 may be configured to be activated or deactivated depending on whether there is an interface to which to be shifted.

The shift icons 224 may be configured to perform their corresponding actions or operations by scrolling, swiping, pushing or flicking from left to right or vice versa. For example, a screen change may be made by swiping on the interface screen from right to left or from left to right.

A specific day selection icon 225 may be provided in the center of the number icons 221.

The specific day may be today, tomorrow, or the day after tomorrow relative to the day that a reservation is made and be set to differ for each of the year input interface, month input interface, and day input interface.

For example, as shown in FIGS. 4a, 4b, and 4c, the specific day selection icon 225 displayed on the year input interface may be shown as ‘today.’ the specific day selection icon 225 on the month input interface as ‘tomorrow,’ and the specific day selection icon 225 on the day input interface as ‘day after tomorrow,’ and this way allows for a quick choice of a specific day in relation to the reservation day.

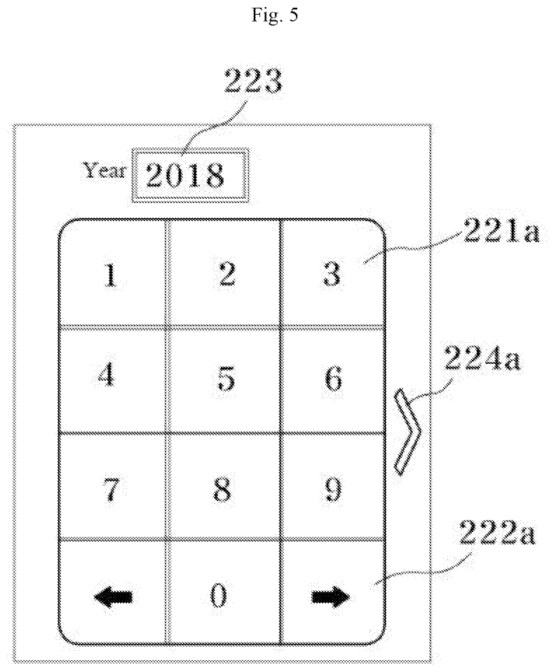

FIG. 5 is a view illustrating examples of a date input interface applied to a time information setting device according to an embodiment.

Referring to FIG. 5, a date input interface for entering a year, month, or day may include number icons 221a configured in the form of a phone number pad, edit icons 222a to edit a selected number, a selection display window 223a to display a selected number, and a shift icon 224a to shift to another date input interface. Although FIG. 5 illustrates a year input interface as an example of the date input interface, the same configuration may also apply to the month input interface and the year input interface.

The time input interface 230 may be an interface for entering a reservation time based on a date input through the date input interface.

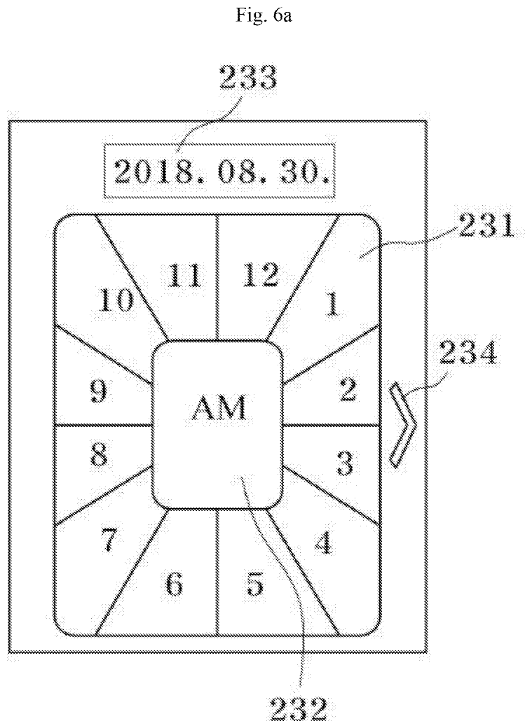

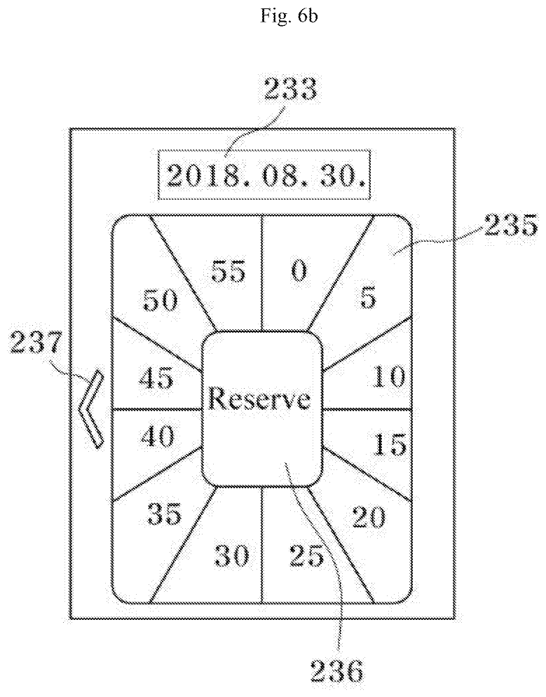

FIGS. 6a and 6b are views illustrating examples of a time input interface applied to a time information setting device according to an embodiment.

FIG. 6a illustrates a hour input interface for entering the hour of a reservation time, and FIG. 6b illustrates a minute input interface for entering the minute of the reservation time.

Referring to FIG. 6a, the interface for entering the hour of a reservation time, i.e., the hour input interface, may include hour selection icons 231 in sections partitioned per hour on a clock-look background, an AM/PM selection icon 232 in the center of the hour selection icons 231, a date display window 233 to display the date entered through the date input interface 220, and a shift icon 234 to shift to the minute input interface.

The AM/PM selection icon 232 may be configured to switch between AM and PM by selecting (e.g., touching) the AM/PM selection icon 232.

Referring to FIG. 6b, the interface for entering the minute of a reservation time, i.e., the minute input interface, may include minute selection icons 235 in sections partitioned per minute on a clock-look background, a reservation icon 236 in the center of the minute selection icons 235, a date display window 233 to display the date entered through the date input interface 220, and a shift icon 237 to shift to the hour input interface.

Input reservation information may be generated and transmitted to the reservation managing server 30 by selecting (e.g., touching) the reservation icon 236.

Although FIG. 6 illustrates an example in which 12 minute selection icons 235, each of which is set in five-minute units, are included, embodiments of the disclosure are not limited thereto. The five-minute units are set based on the reservation time interval set by the reservation setting interface 210 and, where the reservation time interval is set to 10 minutes, six minute selection icons 235 may be partitioned from each other every 10 minutes. Likewise, three minute selection icons 235 may be shown where the reservation time interval is 20 minutes.

The hour input interface and the minute input interface may be configured to display a result of a reservation previously set by a third-party customer.

For example, the hour input interface and the minute input interface may be configured to display the time section (e.g., hour section or minute section) corresponding to the hour or minute set by the third party and the other available time sections in different colors based on the confirmed reservation information corresponding to the result of reservation preset by the third party or to prohibit the time section preset by the third party from selection, thereby preventing a duplicate reservation.

The confirmed reservation information is information regarding a reservation previously made and confirmed, which is received from the reservation managing server 30 via a communication network.

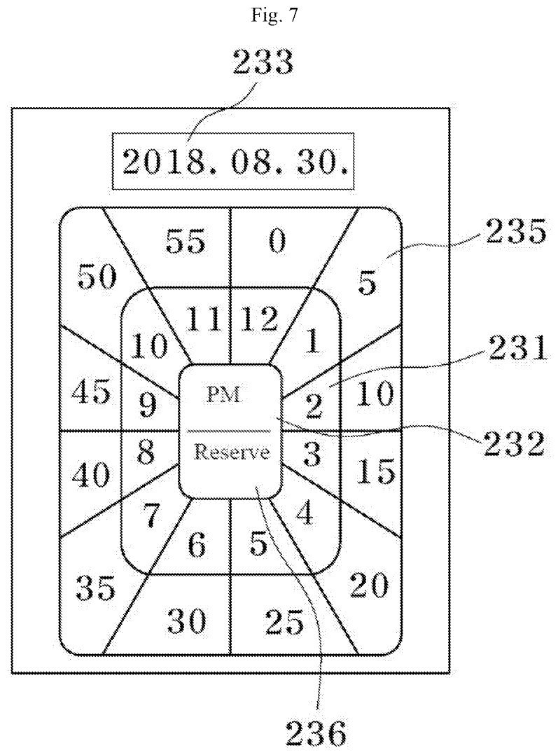

FIG. 7 is a view illustrating an example of a time input interface applied to a time information setting device according to an embodiment, wherein the time input interface may be a combination of a hour input interface and a minute input interface as described above.

Referring to FIG. 7, a time input interface which may be a combination of a hour input interface and a minute input interface may include minute selection icons 235 in sections partitioned per minute on a clock-look background, hour selection icons 231 in sections partitioned per hour which are positioned inside the minute selection icons 235 (e.g., surrounded by the minute selection icons 235), an AM/PM selection icon 232 and a reservation icon 236 in the center of the hour selection icons 231, and a date display window 233 to display the date entered through the date input interface 220.

The above-described configuration of time input interface may provide a user-centered, or user-friendly interface which is capable of easier entry of reservation information and display of information about reservation previously made to prevent duplicate reservations from being made.

The interface for entry of a date, time, and minute is displayed on the touchscreen, allowing the user easy and convenient selection or input on a mobile device with a smaller screen size than, e.g., personal computers, or even on a smartwatch with a much smaller screen.

The confirmed reservation interface 240 is an interface for the manager to check confirmed reservation information regarding confirmed reservations. The confirmed reservation interface 240 may display confirmed reservation information regarding reservations set by reservers or customers.

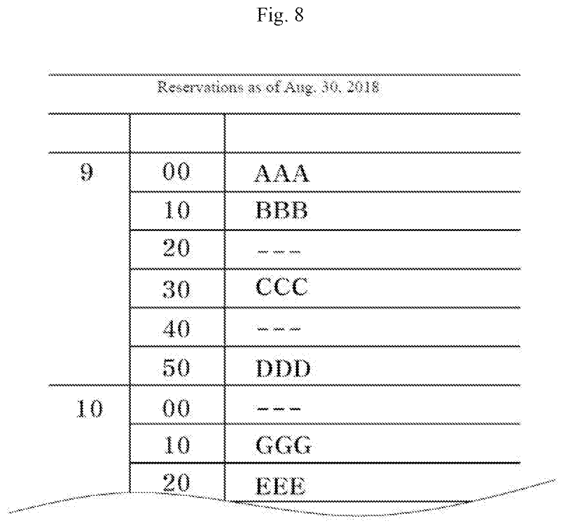

FIG. 8 is a view illustrating an example of a confirmed reservation interface applied to a time information setting device according to an embodiment.

Referring to FIG. 8, a confirmed reservation interface may display the names (or identities (IDs)) of reservers in a data table as per preset time intervals.

The interface unit 200 may further include a login interface to allow the names of the reservers registered in the data table to automatically be input or entered into the data table.

The database 300 may store and manage input reservation information entered through the interface unit 200 and be, or be included in, at least part of the memory 12 of the electronic device.

The reservation information controller 400 may control the screen displayed on the interface based on setting reservation information including reservable dates and times, send the input reservation information through the reservation information transceiver to the reservation managing server, and control the sections displayed on the interface based on confirmed reservation information received from the reservation managing server.

For example, the reservation information controller 400 may be configured to display the sections corresponding to the preset hours and minutes of the confirmed reservation information and other available sections, among the sections displayed on the interface unit 200, in different colors or to prohibit the sections corresponding to the confirmed reservation information from being selected, thereby preventing duplicate reservations.

The reservation information transceiver 100, the interface unit 200, the database 300, and the reservation information controller 400 may be configured in a single application or in their respective corresponding applications to be installed on the electronic device or, as necessary, installed on and deleted from the electronic device.

According to various embodiments, there may be provided a user-centered or user-friendly interface allowing for entry of reservation information, e.g., reservation date or time, in an easy and convenience manner.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A time setting device installed on an electronic device including a communication unit, a memory, a touchscreen, a controller, and a key input device, the time setting device configured to display time sections partitioned per hour or minute on a clock-shaped background, enable a reservation to be set by selecting at least one of the time sections, and display preset reservation information on at least one of the time sections.

2. A time setting device, comprising:
a reservation information transceiver configured to receive confirmed reservation information regarding a reservation previously made and confirmed from a reservation managing server through a communication network or transmit input reservation information entered to the reservation managing server through the communication network;
an interface unit configured to display time sections partitioned per hour or per minute on a clock-shaped background on a touchscreen;
a database configured to store and manage the input reservation information entered through the interface unit; and
a reservation information controller configured to control a screen displayed on the interface unit based on setting reservation information including a reservable date or a reservable time, transmit the input reservation information through the reservation information transceiver to the reservation managing server, and control the time sections displayed on the interface unit based on the confirmed reservation information received from the reservation managing server.

3. The time setting device of claim 2, wherein the interface unit includes a date input interface configured to enter a year, a month, or a day and a time input interface configured to enter a reservation time based on a date entered through the date input interface.

4. The time setting device of claim 2, wherein the interface unit, the database, and the reservation information controller are configured in an application installed on an electronic device including a communication unit, a memory, a touchscreen, a controller, and a key input device.

5. The time setting device of claim 4, wherein the electronic device includes at least one of a mobile device or a smartwatch.
